(19) United States
(12) Patent Application Publication
(10) Pub. No.: US 2010/0158007 A1
(43) Pub. Date: Jun. 24, 2010

(54) METHOD AND APPARATUS FOR AGGREGATING SINGLE PACKETS IN A SINGLE SESSION

(75) Inventors: Sang Wan Kim, Daejeon (KR); Sang Sik Yoon, Gwangju (KR); Dong Won Kang, Daejeon (KR); Tae Sang Choi, Daejeon (KR); Joon Kyung Lee, Daejeon (KR); You Hyeon Jeong, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/507,138

(22) Filed: Jul. 22, 2009

(30) Foreign Application Priority Data
Dec. 19, 2008 (KR) 10-2008-0130126

(51) Int. Cl. H04L 12/56

(52) U.S. Cl. 370/392

(57) ABSTRACT

A method and apparatus for aggregating single packets in a single session are disclosed. If the amount of single packets in a single session exceeds a threshold value, it is detected that attack traffic is being inputted and the single packets in the single session are aggregated into a single flow, thus preventing degradation of a network performance due to the single packets in the single session.

### CROSS-REFERENCE TO RELATED APPLICATIONS

This application claims the priority of Korean Patent Application No. 10-2008-0130126 filed on Dec. 19, 2008, in the Korean Intellectual Property Office, the disclosure of which is incorporated herein by reference.

### BACKGROUND OF THE INVENTION

1. Field of the Invention

The present application relates to a technique that processes single packets (i.e., the same, equal packets) in a single session (in one session) caused by attack traffic and, more particularly, to a method and apparatus for aggregating single packets in a single session to thus prevent degradation of a network's performance due to single packets in a single session.

2. Description of the Related Art

One of the most significant factors inhibiting the performance of network devices for data packet processing is a single session wherein single packets (i.e., the same packets) are input in large numbers to rapidly increase the packet processing load of the network devices.

In general, normal traffic includes a plurality of packets in the same session, while most attack traffic consists of single packets generated in a single session.

If a network's equipment receives such attack traffic, its processing load is rapidly increased to process the attack traffic, and in a worst case scenario, the overall network function is paralyzed.

Thus, network devices for monitoring the general operational situation of a network, such as traffic monitoring systems, traffic control systems, charging systems (i.e., billing systems), intrusion detection systems, and the like, must properly process single data packets generated in a single session to prevent degradation of performance in the network device beforehand.

### SUMMARY OF THE INVENTION

An aspect of the present application provides a method and apparatus for aggregating single packets in a single session capable of detecting packets as attack traffic if the amount of single packets is excessively increased in a single session, and aggregating the single packets into a single flow to thus prevent degradation of a network's performance due to the attack traffic.

According to an aspect of the present application, there is provided a method for aggregating single packets in a single session, including: if single packets in a single session are inputted, checking a single packet processing reference and selecting one among a packet processing threshold value (Las) for each autonomous system (AS), a packet processing threshold value (Lh) for each host, and an overall system packet processing threshold value (Ls); and if the amount of the single packets in a single session is lager than the selected packet processing threshold value, aggregating the single packets in the single session into a single flow.

The aggregating the single packets in the single session into a single flow, includes; if the single packet processing reference is set as the Las and there is an AS to which a larger amount of single packets in the single session than the Las have been input, aggregating the single packets in the single session of the AS into a single flow so as to be processed; if the single packet processing reference is set as the Lh and there is a host to which a larger amount of single packets in the single session than the Lh has been input, aggregating the single packets in the single session of the host into a single flow so as to be processed; and if the single packet processing reference is set as the Ls and the amount of single packets in the single session input to the entire system exceeds the Ls, aggregating the single packets in the single session of the entire system into a single flow so as to be processed.

The aggregating the single packets in the single session into a single flow, comprises: if the single packet processing reference is set as the Las for each autonomous system (AS) and there is an AS to which a larger amount of single packets in a single session than the Las have been input, aggregating the single packets in the single session of the AS into a single flow so as to be processed; if the single packet processing reference is set as the Lh for each host and there is a host to which a larger amount of single packets in a single session than the Lh has been input, aggregating the single packets in the single session of the host into a single flow so as to be processed; and if the single packet processing reference is set as the Ls and the amount of single packets in a single session input to the entire system exceeds the Ls, aggregating the single packets in the single session of the entire system into a single flow so as to be processed.

The method for aggregating single packets in a single session may further include: setting the single packet processing reference, the Las, the Lh, and the Ls.

The aggregating of the single packets in the single session of the AS into a single flow so as to be processed may include: totaling the single packets in the single session input by each AS; comparing the amount of single packets in the single session input by each AS and the Las; and aggregating the single packets in the single session of the AS in which a larger amount of single packets in the single session than the Las into a single flow so as to be processed.

The aggregating of the single packets in the single session of the host into a single flow so as to be processed may include: totaling the single packets in the single session input by host; comparing the amount of single packets in the single session input by host and the Lh; and aggregating the single packets in the single session of the host in which the amount of single packets in the single session exceeds the Lh into a single flow so as to be processed.

The aggregating of the single packets in a single session of the overall system into a single flow so as to be processed may include: totaling the amount of single packets in the single session input to the entire system; and if the amount of single packets in the single session input to the entire system exceeds the Ls, aggregating the single packets in the single system of the entire system into a single flow so as to be processed.

The system may be one of a traffic monitoring system, a traffic control system, a charging system, and an intrusion detection system.

According to an aspect of the present application, there is also provided an apparatus for aggregating single packets in a single session, including: a single packet traffic detection unit that detects a single packet input to a single session; a single packet statistics processing unit that totals the amount of single packets in the single session; and a single packet processing unit that aggregates the single packets in the single session into a single flow and processes the same, if the amount of single packets in the single session exceeds a packet processing threshold value.

The single packet statistics processing unit may total the amount of single packets in a single session by AS, the amount of single packets in a single session by host, and the amount of single packets in a single session of an entire system.

The single packet processing unit may analyze the amount of single packets in a single session by selecting one of a packet processing threshold value set for each AS, a packet processing threshold value set for each host, and a packet processing threshold value for an overall system (i.e., entire system) according to a single packet processing reference, and then, if input attack traffic is detected, the single packet processing unit may aggregate the single packets in the single session into a single flow to process the same.

The apparatus for aggregating single packets in a single session may further include: a user interface unit that receives the single packet processing reference, the Las, the Lh, and the packet processing threshold value set for the overall system, provides them to the single packet processing unit, and informs about a processing result of the single packet processing unit.

The apparatus for aggregating single packets in a single session may further include: a packet transmission unit that converts packets or a single flow transmitted via the single packet processing unit into a format that can be connected with an external network device.

### BRIEF DESCRIPTION OF THE DRAWINGS

The above and other aspects, features and other advantages of the present application will be more clearly understood from the following detailed description taken in conjunction with the accompanying drawings, in which:

FIG. 1 is a schematic block diagram of an apparatus for aggregating single packets in a single session according to an exemplary embodiment of the present application; and

FIG. 2 is a flowchart illustrating the process of a method for aggregating single packets in a single session according to an exemplary embodiment of the present application.

### DETAILED DESCRIPTION OF THE PREFERRED EMBODIMENT

Exemplary embodiments of the present application will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

In addition, unless explicitly described to the contrary, the word “comprise” and variations such as “comprises” or “comprising,” will be understood to imply the inclusion of stated elements but not the exclusion of any other elements.

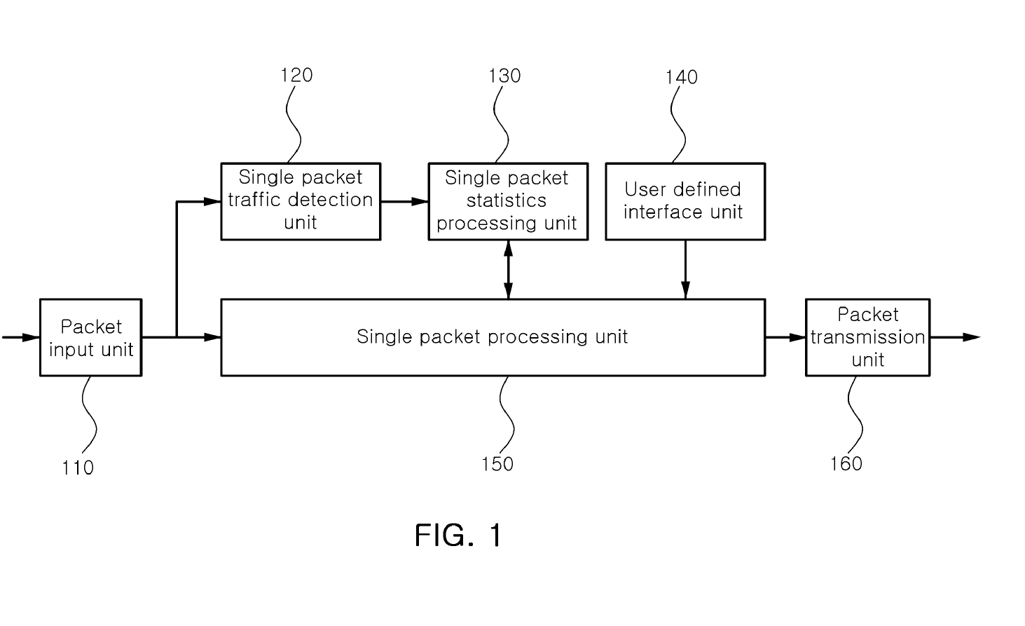

FIG. 1 is a schematic block diagram of an apparatus for aggregating single packets in a single session according to an exemplary embodiment of the present application.

With reference to FIG. 1, the apparatus for aggregating single packets in a single session according to an exemplary embodiment of the present application includes a packet input unit 110, a single packet traffic detection unit 120, a single packet statistics processing unit 130, a user interface unit 140, a single packet processing unit 150, and a packet transmission unit 160.

The functions of each element will now be described.

The packet input unit 100 receives and processes traffic transmitted from the exterior.

The single packet traffic detection unit 120 detects whether or not traffic transmitted from the exterior is a single session including single packets (referred to as ‘single packets in a single session’, hereinafter), and informs the single packet statistics processing unit 130 accordingly.

When the single packet statistics processing unit 130 is informed of the input of single packets in a single session by the single packet traffic detection unit 120, it maintains and manages the statistics values (Oas, Oh, Os) of the single packets in the single session.

In this case, Oas refers to the amount of single packets in a single session input to each autonomous system (AS), Oh refers to the amount of single packets in a single session input to each host, and Os refers to the amount of single packets in a single session input to the entire system employing the apparatus for aggregating single packets in a single session.

The user interface unit 140 acquires information about packet processing threshold values (Las, Lh, Ls) and a single packet processing reference, based on which single packets in a single session are to be aggregated, set by a manager, provides the acquired information to the single packet processing unit 150, and informs the manager about a processing result of the single packet processing unit 150.

In this case, Las is a packet processing threshold set value for processing packets in a single session to be aggregated and processed into a single flow by each AS, Lh is a packet processing threshold set value for processing packets in add single session to be aggregated and processed into a single flow by each host, and Ls is a packet processing threshold set value for processing packets in a single session to be aggregated and processed into a single flow based on the entire system. The single packet processing reference includes information about which one of the packet processing threshold values is to be used to detect and aggregate input attack traffic.

The single packet processing unit 150 selects one of the packet processing threshold values (Las, Lh, Ls) as an attack traffic input detection reference according to the single packet processing reference, and analyzes the amount of single packets (Oas, Oh, Os) in the single session based on the attack traffic input detection reference to check whether attack traffic has been inputted. Upon checking, if attack traffic has been inputted, the single packet processing unit 150 aggregates the single packets in the corresponding single session into a single flow to prevent degradation of a network's performance due to the attack traffic.

The packet transmission unit 160 converts the packets or the single flow transmitted via the single packet processing unit 150 into a format that can be shared with an external network device, and outputs the converted format to the exterior.

In addition, the apparatus for aggregating single packets in a single session as shown in FIG. 1 may be configured as a single network device or may be implemented as an internal element of a traffic monitoring system, a traffic control system, a charging system, and an intrusion detection system.

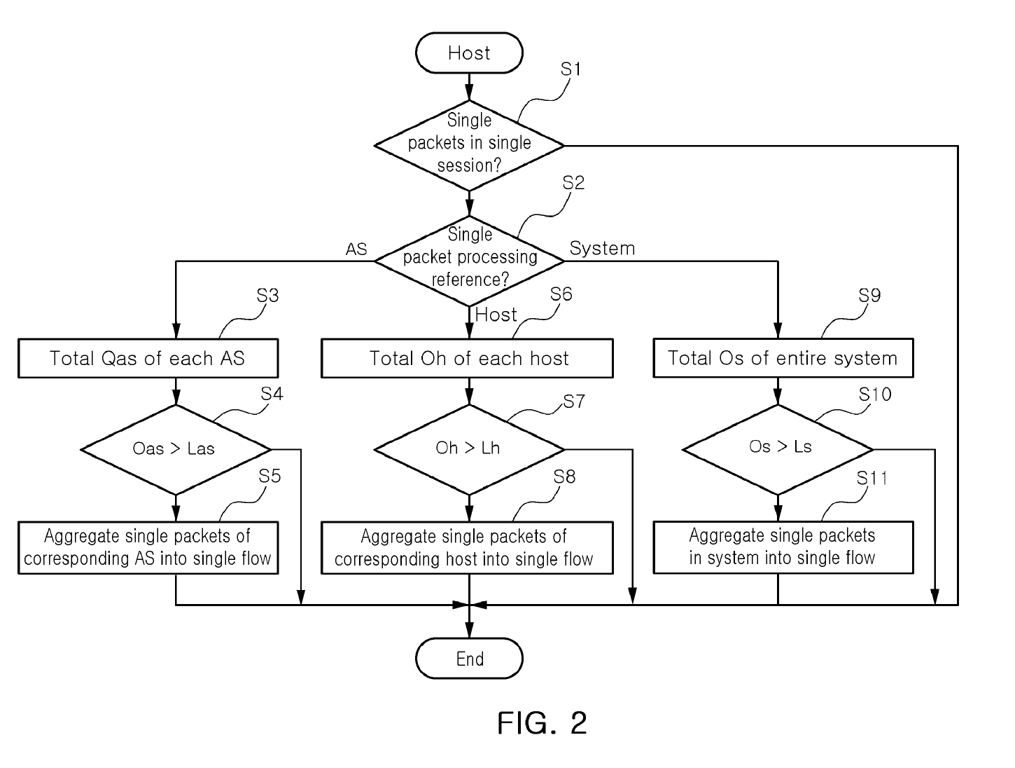

FIG. 2 is a flow chart illustrating the process of a method for aggregating single packets in a single session according to an exemplary embodiment of the present application.

Before performing the method for aggregating single packets in a single session, an initialization process is performed to receive the information about the packet processing threshold values (Las, Lh, Ls), and the single packet processing reference from the manager.

When the initialization process is successfully performed, an operation of aggregating single packets in a single session is substantially performed. Accordingly, when traffic starts to be input from the exterior, it is checked to determine whether or not currently input traffic is a single packet in a single session (S1).

Upon checking in step S1, if a single packet is input in a single session, the single packet processing reference set through the initialization process is checked and one of the packet processing threshold values (Las, Lh, Ls) is selected as a reference for detecting an input of attack traffic (S2).

If the packet processing threshold value (Las) of each AS has been set as the single packet processing reference in step S2, the amount of single packets (Oas) in the single session of each AS is totaled (S3).

The amount of single packets (Oas) in the single session of each AS and the packet processing threshold value (Las) of each AS are compared (S4). If the amount of single packets (Oas) in a single session of a particular exceeds the packet processing threshold value (Las) of each AS, the single packets in the single session of the corresponding AS are aggregated into a single flow (S5).

If the packet processing threshold value (Lh) of each host has been set as the single packet processing reference, the amount of single packets in the single session of each host is totaled (S6).

The amount of single packets (Oh) in the single session of each host and the packet processing threshold value (Lh) are compared (S7), and if the amount of single packets in the single session of a particular host exceeds the packet processing threshold value (Lh) of each host, the single packets in the single session of the corresponding host are aggregated into a single flow (S8).

Meanwhile, if the packet processing threshold value (Lh) of the entire system has been set as the single packet processing reference, the amount (Os) of single packets in the single session of the entire system is totaled (S10).

The amount (Os) of single packets in the single session of the entire system and the packet processing threshold value (Lh) of the entire system are compared (S11). If the amount (Os) of the single packets in the single session of the entire system exceeds the packet processing threshold value (Lh) of the entire system, the single packets in the single session input to the entire system are aggregated into a single flow (S12).

In this manner, in the method for aggregating single packets in a single session according to the exemplary embodiment of the present application, if attack traffic is generated, single packets in a single session input to the entire system are increased to abnormal levels, the abnormal increase in single packet numbers is instantly detected and the corresponding packets are aggregated into a single flow so as to be processed.

Thus, although attack traffic is generated, the possibility of degradation of a network's performance can be prevented beforehand.

As set forth above, in the method and apparatus for aggregating single packets in a single session according to exemplary embodiments of the invention, single packets in a single session caused by attack traffic are aggregated into a single flow, thus preventing the degradation of a network's performance due to the single packets in the single session.

While the present application has been shown and described in connection with the exemplary embodiments, it will be apparent to those skilled in the art that modifications and variations can be made without departing from the spirit and scope of the invention as defined by the appended claims.

What is claimed is:

1. A method for aggregating single packets in a single session, the method including:
if single packets in a single session are inputted, checking a single packet processing reference and selecting one among a packet processing threshold value (Las) for each autonomous system (AS), a packet processing threshold value (Lh) for each host, and an overall system packet processing threshold value (Ls); and
if the amount of the single packets in a single session is lager than the selected packet processing threshold value, aggregating the single packets in the single session into a single flow.

2. The method of claim 1, wherein the aggregating the single packets in the single session into a single flow, comprises:
if the single packet processing reference is set as the Las and there is an AS to which a larger amount of single packets in the single session than the Las have been input, aggregating the single packets in the single session of the AS into a single flow so as to be processed;
if the single packet processing reference is set as the Lh and there is a host to which a larger amount of single packets in the single session than the Lh has been input, aggregating the single packets in the single session of the host into a single flow so as to be processed; and
if the single packet processing reference is set as the Ls and the amount of single packets in the single session input to the entire system exceeds the Ls, aggregating the single packets in the single session of the entire system into a single flow so as to be processed.

3. The method of claim 2, further comprising:
setting the single packet processing reference, the Las, the Lh, and the Ls.

4. The method of claim 2, wherein the aggregating of the single packets in the single session of the AS into a single flow so as to be processed, comprises:
totaling the single packets in the single session inputted by AS;
comparing the amount of single packets in the single session inputted by AS and the Las; and
aggregating the single packets in the single session of the AS in which a larger amount of single packets in the single session than the Las into the single flow so as to be processed.

5. The method of claim 2, wherein the aggregating of the single packets in the single session of the host into a single flow so as to be processed, comprises:
totaling the single packets in the single session inputted by host;
comparing the amount of single packets in the single session inputted by each host and the Lh; and
aggregating the single packets in the single session of the host in which a larger amount of single packets in the single session than the Lh into the single flow so as to be processed.

6. The method of claim 2, wherein the aggregating of the single packets in a single session of the overall system into a single flow so as to be processed, comprises:
totaling the amount of single packets in the single session input to the entire system; and
if the amount of single packets in the single session input to the entire system exceeds the Ls, aggregating the single packets in the single system of the entire system into a single flow so as to be processed.

7. The method of claim 2, wherein the system is one of a traffic monitoring system, a traffic control system, a charging system, and an intrusion detection system.

8. An apparatus for aggregating single packets in a single session, the apparatus comprising:
a single packet traffic detection unit that detects a single packet input to a single session;
a single packet statistics processing unit that totals the amount of single packets in the single session; and
a single packet processing unit that aggregates the single packets in the single session into a single flow and processes the single flow, if the amount of single packets in the single session exceeds a packet processing threshold value.

9. The apparatus of claim 8, wherein the single packet statistics processing unit totals the amount of single packets in a single session by AS, the amount of single packets in a single session by host, and the amount of single packets in a single session of an entire system.

10. The apparatus of claim 9, wherein the single packet processing unit analyzes the amount of single packets in a single session by selecting one of a packet processing threshold value set for each AS, a packet processing threshold value set for each host, and a packet processing threshold value for an overall system according to a single packet processing reference, and then, if input attack traffic is detected, the single packet processing unit aggregates the single packets in the single session into a single flow to process the same.

11. The apparatus of claim 10, further comprising:
a user interface unit that receives the single packet processing reference, the Las, the Lh, and the packet processing threshold value for the overall system, provides them to the single packet processing unit, and informs about a processing result of the single packet processing unit.

12. The apparatus of claim 8, further comprising:
a packet transmission unit that converts packets or a single flow transmitted via the single packet processing unit into a format that can be connected with an external network device.

13. The apparatus of claim 9, wherein the system is one of a traffic monitoring system, a traffic control system, a charging system, and an intrusion detection system.
